(19) United States
(12) Patent Application Publication
(10) Pub. No.: US 2010/0227069 A1
(43) Pub. Date: Sep. 9, 2010

(54) APPARATUS FOR REDUCING COST OF DEVELOPER AND THE METHOD THEREOF

(75) Inventors: Chiang-Lin Shih, Taipei County (TW); Pei-Lin Huang, Taipei City (TW); Ying-Chung Tseng, Taipei County (TW)

Correspondence Address: VOLPE AND KOENIG, P.C., UNITED PLAZA, 30 SOUTH 17TH STREET, PHILADELPHIA, PA, 19103, US

(73) Assignee: NANYA TECHNOLOGY CORP., Tao-Yuan Hsien (TW)

(21) Appl. No.: 12/500,995

(22) Filed: Jul. 10, 2009

(30) Foreign Application Priority Data
Mar. 5, 2009 (TW) 098107204

(51) Int. Cl. B05D 3/12; B05D 3/00; B05C 11/00

(52) U.S. Cl. 427/346; 427/372.2; 118/612

(57) ABSTRACT

An apparatus for homogenizing the developer concentration on the wafer and reducing the developer cost and the method thereof are provided in the present invention. The developer is provided on the wafer which then is spun to distribute the developer on the wafer. Next, the mechanical turbulence of the developer is produced on the wafer by the turbulence device or the mega-sonic vibrator. The apparatus is able to improve the uniformity of developer concentration, and the developer consumption is reduced.

### FIELD OF THE INVENTION

The present invention relates to an apparatus for homogenizing the developer concentration in the semiconductor manufacturing processes and the method for reducing the cost because of the developer usage.

### BACKGROUND OF THE INVENTION

The microlithography technique plays the key role in all semiconductor manufacturing processes. This technique resembles the exposure/development in photography to faithfully represent the blueprint designed by the IC engineer on the chip by using the exposure/development technique. Certainly, many limited factors appear in the semiconductor manufacturing development with the minimized chip size and high pattern density. One urgently solved factor is the problem that the uniformity of the critical dimension (CD) cannot be maintained at different pattern densities in the developing process when CD is continuously reduced.

Therefore, how to maintain the developer concentration in the semiconductor manufacturing processes (i.e. developer consumption) and reduce the developer cost and the operation time so as to maintain the uniformity of the identical CD are the problems we face. Please refer to Table 1, which illustrates the result of the pattern density measured in the photomask in the prior art. First, two photomasks with different transmissions are provided, one is the WN photomask with 10.10% of transmission, the other is the WA photomask with 55.90% of transmission. When the identical exposure energy is utilized, the developer consumptions are diverse because of different photomasks having different pattern densities. Therefore, CDs at the center and at the edge of the photomask are also diverse after exposure. For instance, the method is traditionally used in FIG. 1 and Table 2, which are the individually exposure results of two photomasks. First, CDs at five points, Points 1 to 5, are measured respectively. After the wafer is entirely exposed under the WN photomask, the mean CD of these five points is 940.4 nm. However, after the wafer is entirely exposed under the WA photomask, the mean CD of these five points is 837.0 nm. In this instance, although both use the entire exposure, the developer consumptions are different because of the various pattern densities on the photomask. It results in the irregular jump within these five CD values (shown in Table 2).

TABLE 1

| Photomask | Transmission | CD (nm) | Position |
|---|---|---|---|
| WN | 10.10% | 979.45 | Center |
| | | 977.45 | Edge |
| WA | 55.90% | 906.3 | Center |
| | | 901.95 | Edge |

TABLE 2

| WA mask | CD (nm) | WN mask | CD (nm) |
|---|---|---|---|
| 1 | 831.7 | 1 | 939.44 |
| 2 | 840.14 | 2 | 933.48 |
| 3 | 826.76 | 3 | 936.97 |
| 4 | 840.84 | 4 | 947.83 |
| 5 | 853.53 | 5 | 942.22 |
| Mean | 837.0 | Mean | 940.4 |

Next, please refer to FIG. 2, which illustrates the measurement by using the checkerboard (CHK) exposure, and Table 3, which represents the result of two photomasks after the interval exposure according to FIG. 2. The WN photomask and the WA photomask are exposed at interval, then five points at the WN photomask and at the WA photomask on the same wafer are respectively measured. It can be found that the deviation within these five CDs is much larger than that in Table 2 (please also refer to Table 3).

TABLE 3

| WA mask | CD (nm) | WN mask | CD (nm) |
|---|---|---|---|
| 1 | 850.74 | 1 | 932.01 |
| 2 | 899.59 | 2 | 861.22 |
| 3 | 903.27 | 3 | 873.96 |
| 4 | 919.81 | 4 | 846.43 |
| 5 | 941.93 | 5 | 925.53 |
| Mean | 883.1 | Mean | 887.8 |

Please refer to Table 4 and FIG. 3, where Table 4 represents the measurement result after the conditional factors are improved, and FIG. 3 illustrates the range relationship of CD plotted corresponding to Table 4. In FIG. 3, the ordinate is CD, and the abscissa means the measurement point. The CHK exposure is utilized cooperated with the multi-developments. Please refer to the results in two columns, WN normal exposure (WN POR) and WA normal exposure (WA POR), in Table 4 and the reference numeral 101 in FIG. 3, these two columns are the exposure results when the first developer is provided on the photomasks. The results render the variations of five CD values between the WN photomask and the WA photomask on the wafer. The ranges of CD in these two columns are relatively large. Next, please refer to the results in two columns, WN improvement I (WN 2P) and WA improvement I (WA 2P), in Table 4 and the reference numeral 102 in FIG. 3, the largest deviation ranges of CD in these two columns have been reduced to 26.8 nm and 46.1 nm respectively when the second developer is provided thereon. Please refer to the result in two columns, WN improvement II (WN 3P) and WA improvement II (WA 3P), in Table 4 and the reference numeral 103 in FIG. 3, the largest deviation ranges of CD have been reduced to 7.6 nm and 9.2 nm respectively when the third developer is provided thereon. The largest deviation range in this method is reduced much lower than that in the normal exposure. However, the much larger deviation range still exists on the wafer. Therefore, if fresh developer is continuously provided onto the wafer, the less smaller deviation range of CD is possible. Therefore, in the prior art, the uniformity of developer concentration is maintained by continuously providing fresh developer and multi-developments on the substrate to maintain the constant developer consumption rate and result in the uniformity of CD value.

TABLE 4

| Measure- | | | | | | |
|---|---|---|---|---|---|---|
| ment | WN POR | WN 2P | WN 3P | WA POR | WA 2P | WA 3P |
| 1 | 932.01 | 940.1 | 981.3 | 850.74 | 926.4 | 947.7 |
| 2 | 866.22 | 927.8 | 973.7 | 899.59 | 940.6 | 947.6 |
| 3 | 873.96 | 936.5 | 979.8 | 903.27 | 955.6 | 981.9 |
| 4 | 846.43 | 940.8 | 974.6 | 919.81 | 952.4 | 972.7 |
| 5 | 925.53 | 954.6 | 981.3 | 841.93 | 909.5 | 976 |
| Mean | 887.83 | 939.96 | 987.14 | 883.068 | 936.9 | 975.98 |
| Range | 85.58 | 26.8 | 7.6 | 77.88 | 46.1 | 9.2 |

Unit: nanometer (nm)

Please continuously refer to FIG. 4, which illustrates the relationship between puddle count and the CD mean plotted corresponding to Table 4. The abscissa represents the puddle count, and the ordinate represents the CD mean. From FIG. 4, it is known that the CD means in WA photomask and WN photomask are 887.83 nm and 883.068 nm respectively after the first development. After three repeated developments, CD means in WN photomask and WA photomask almost tend to identity. However, if this method is adopted, fresh developer must be continuously provided to result in the much higher cost and more manufacturing time.

It is therefore attempted by the applicant to deal with the above situation encountered in the prior art.

### SUMMARY OF THE INVENTION

The present invention relates to the apparatus for improving the homogeneity/uniformity of the developer concentration and the method thereof. In order to achieve this purpose, an apparatus having an uneven outer bottom surface is provided in the present invention. The homogeneity/uniformity of developer concentration and reducing the developer cost are achieved by disturbing the developer with this bottom surface. Further, the identity of CD is achieved which is not influenced by the neighboring pattern densities.

In accordance with the first aspect of the present invention, a developer homogenizing method is provided. The method includes steps of: (a) providing a substrate; (b) substantially uniformly distributing the developer on the substrate; (c) developing the substrate and disturbing the developer simultaneously; and (d) drying out the developer.

Preferably, the substrate is a wafer.

Preferably, the step (b) is performed by a spin coating process.

Preferably, the developer disturbing step is processed by means for generating a turbulence in the developer or by immersing a turbulence device in the developer.

Preferably, the turbulence generating means is a mega-sonic device.

In accordance with the second aspect of the present invention, a homogenizing apparatus for a developer is provided. The apparatus includes: a carrier supporting thereon a substrate; a dropping unit providing the developer on the substrate; and a turbulence device disposed above the carrier for disturbing the developer.

Preferably, the turbulence device is a mega-sonic device.

Preferably, the turbulence device has an uneven outer bottom surface contacted the developer. The uneven outer bottom surface is selected from a group consisting of a plurality of pyramid structures, a plurality of cubic structures, a plurality of hemispheric structures, a plurality of irregular structures and a combination thereof. The uneven outer bottom surface is made of a material selected from a group consisting of a metal, a nonmetal and a combination thereof.

Preferably, the dropping unit is a developer dispenser disposed above the carrier. Alternatively, the dropping unit and the turbulence device are configured on a movable device. Alternatively, the dropping unit is configured in the turbulence device. In one preferred embodiment, the dropping unit is a nozzle.

In accordance with the third aspect of the present invention, a homogenizing apparatus for a developer is provided. The apparatus includes: a carrier supporting thereon a substrate; a developer dispensing unit located on top of the substrate to provide a developer on the substrate; and means for disturbing the developer evenly.

Preferably, the disturbing means is a mega-sonic device.

In accordance with the fourth aspect of the present invention, a homogenizing method for a developer is provided. The method includes steps of: providing a substrate receiving thereon the developer; and evenly disturbing the developer when the substrate is to be developed by the developer.

Preferably, the substrate has two opposite surfaces, and the method further includes a step of distributing the developer over one of the two opposite surfaces by a spin coating process.

Preferably, the developer has a distribution of a concentration and the disturbing step is used for homogenizing the distribution of the concentration.

The above objectives of the present invention will become more readily apparent to those ordinarily skilled in the art after reviewing the following detailed descriptions and accompanying drawings, in which:

### BRIEF DESCRIPTION OF THE DRAWINGS

FIG. 1 illustrates the diagram showing the measurement points of CD by the entire WN photomask or WA photomask exposure in the prior art;

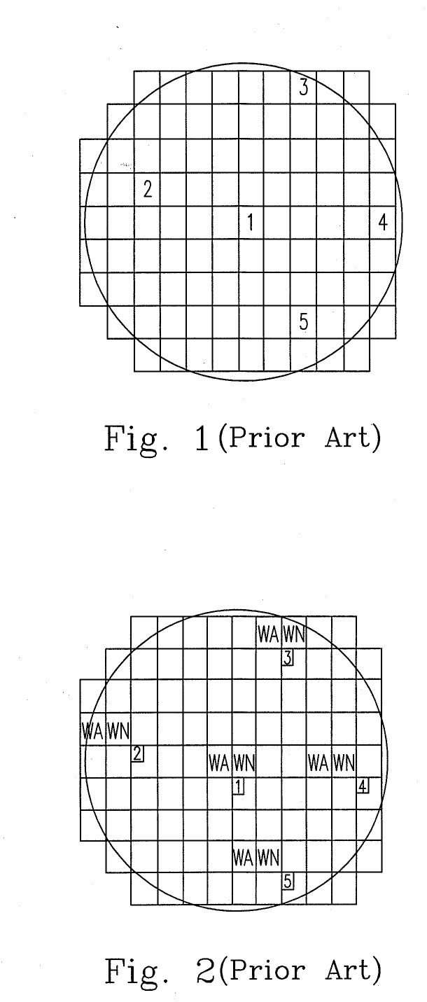

FIG. 2 illustrates the diagram showing the measurement points of CD on the WA photomask and the WN photomask by checkerboard (CHK) exposure in the prior art;

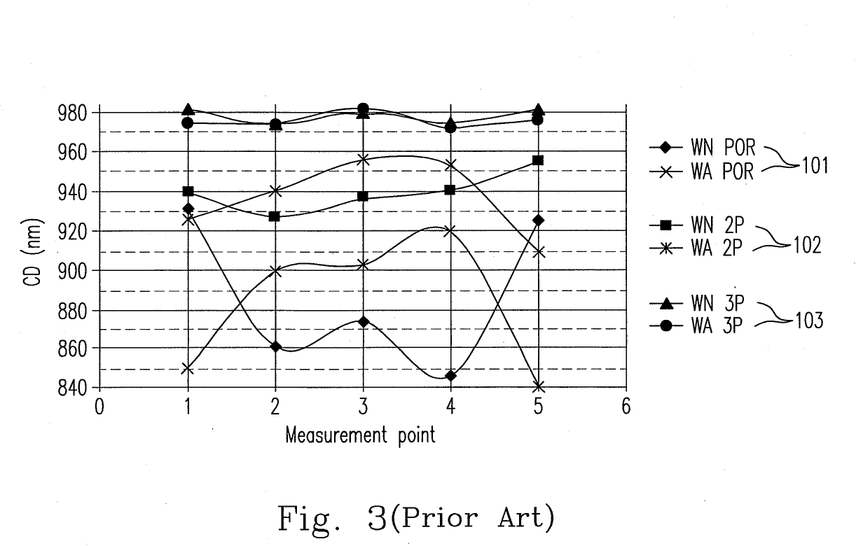

FIG. 3 illustrates the relationship between CD and the measurement points after the improvement of conditional factors in the art, FIG. 3 is plotted according to Table 4;

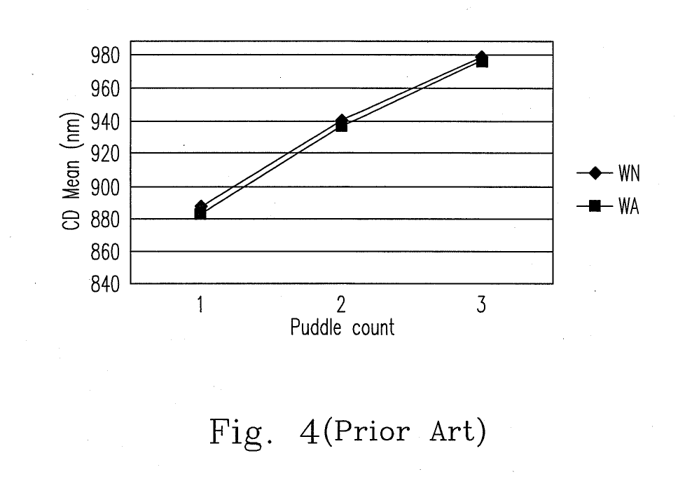

FIG. 4 illustrates the relationship between the puddle count and the CD mean;

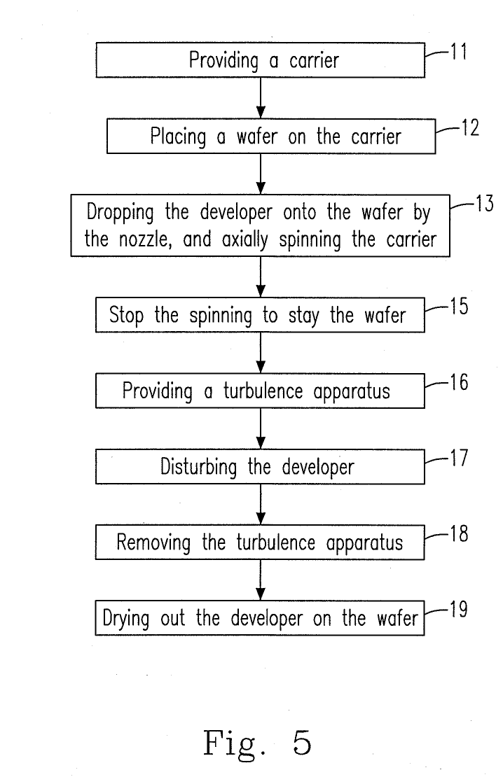

FIG. 5 illustrates a flowchart for improving the uniformity of developer concentration on the wafer in a first preferred embodiment of the present invention;

FIG. 6 illustrate a flowchart for improving the uniformity of developer concentration and reducing the developer cost in a second preferred embodiment of the present invention;

FIGS. 7(A) to 7(C) show the apparatus for improving the uniformity of developer concentration in the first preferred embodiment of the present invention;

FIGS. 8(A) and 8(B) show the apparatus for improving the uniformity of developer concentration in the second preferred embodiment of the present invention; and

FIGS. 9(A) and 9(B) show the apparatus for improving the uniformity of developer concentration in a third preferred embodiment of the present invention.

### DETAILED DESCRIPTION OF THE PREFERRED EMBODIMENT

The present invention will now be described more specifically with reference to the following Embodiments. It is to be noted that the following descriptions of preferred Embodiments of this invention are presented herein for purpose of illustration and description only; it is not intended to be exhaustive or to be limited to the precise form disclosed.

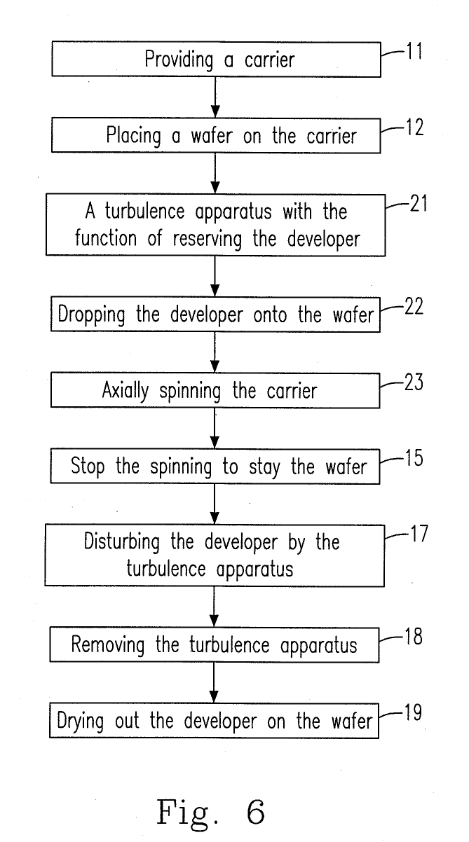

Please refer to FIG. 5, which illustrates a flowchart for improving the uniformity of developer concentration on the wafer in a first preferred embodiment of the present invention. First, a carrier is provided for carrying the wafer (Step 11), and the wafer is placed on the carrier (Step 12). The developer is dropping onto the wafer by the developer nozzle, and the carrier is spun axially. The developer concentration becomes homogenized/uniform on the wafer by centrifugal force in the spin coating process (Step 13). When the developer concentration is almost uniform on the wafer, the carrier is ceased to rotate the wafer, and the developer is developed on the wafer according to the pattern of photomask so as to consume the developer (Step 15). Subsequently, a turbulence device having the turbulence function is provided (Step 16). “Turbulence” is processed by the turbulence device connected with the developer or immersed in the developer. Mechanical turbulence is provided by the outer bottom surface of the turbulence device, which can be substituted as the mega-sonic vibrator, to disturb or vibrate the developer until the developer concentration uniformly distributed on the wafer (Step 17). The turbulence device is removed when the developer is uniformly distributed (Step 18). Finally, the developer is dried out on the wafer (Step 19). The uniformity of developer concentration in the present invention is accomplished in the above-mentioned steps, and the consumption of developer is reduced to save the cost of developer. In addition, the wafer also can be substituted for other substrates or other semiconductor devices.

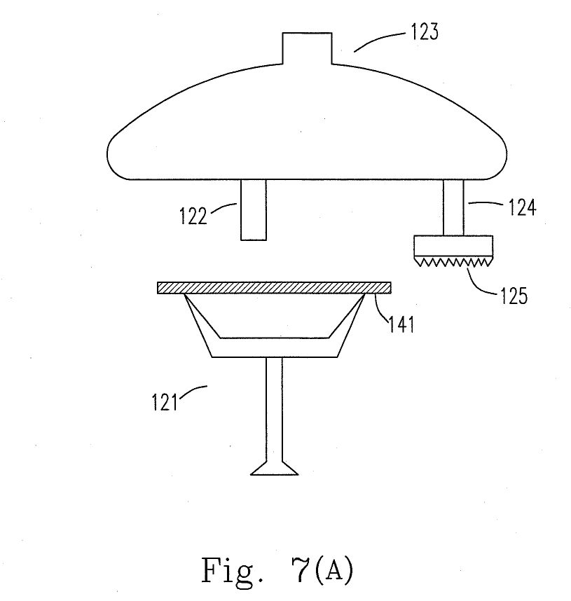

Please refer to FIG. 6, which illustrate a flowchart for improving the uniformity of developer concentration and reducing the developer cost in a second preferred embodiment of the present invention. First, a carrier is provided for carrying a wafer (Step 11), and the wafer is disposed on the carrier (Step 12). Next, a turbulence device having the functions of developer reservation and turbulence is provided (Step 21). The developer is dropped onto the wafer (Step 22), and the carrier is spun axially and horizontally. The developer concentration on the wafer becomes uniform by centrifugal force in the spin coating process (Step 23). When the developer is almost homogenized on the wafer, the carrier is ceased to rotate the wafer, and the developer is developed on the wafer according to the pattern of photomask so as to consume the developer (Step 15). Mechanical turbulence is provided by the outer bottom surface of the turbulence device, which can be substituted as the mega-sonic vibrator, to disturb or vibrate the developer until the developer concentration uniformly distributed on the wafer (Step 17). The mechanism of the generated turbulence in the second preferred embodiment is identical with that in the first preferred embodiment. The turbulence device is removed when the developer is uniformly distributed (Step 18). Finally, the developer is dried out on the wafer (Step 19). The uniformity of the developer concentration in the prevent invention is accomplished in the above-mentioned steps.

In the embodiments of FIGS. 5 and 6, when the developer is developed on the wafer according to the pattern of photomask, the consumption rates of developer are different because of the various pattern densities on the photomask. Therefore, a turbulence device having the turbulence function is provided to produce a mechanical turbulence to the developer. The turbulence device has an uneven bottom outer surface which is constructed from a plurality of pyramid structures, a plurality of cubic structures, a plurality of hemispheric structures, a plurality of irregular structures and the composition thereof. The disturbance device produces turbulence and mixing functions so as to achieve the homogeneity of developer concentration and the uniform consumption rate of developer. The variation of CD will not be enlarged and is maintained because of the uniformity of developer concentration. The material of the uneven outer bottom surface of the turbulence device can be made of metal, nonmetal and the appropriate combination thereof as long as the material does not react with the developer. Further, the mega-sonic vibrator is utilized to vibrate the developer so as to achieve the uniformity of developer concentration. Finally, the developer is dried out on the wafer.

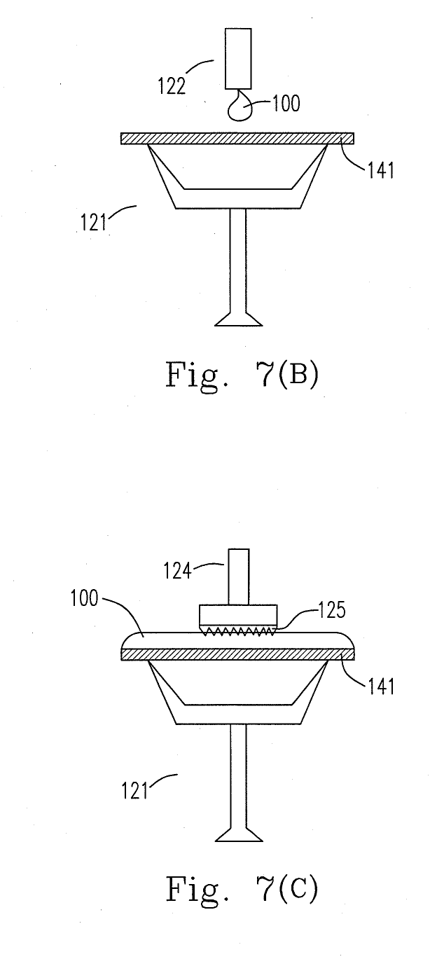

Please refer to FIG. 7(A), which shows the apparatus for improving the uniformity of developer concentration in the first preferred embodiment of the present invention. The apparatus includes a movable device 123 and a carrier 121. The movable device 123 further includes a developer nozzle 122 and a turbulence device 124 having an uneven bottom outer surface 125. The species and positions of the developer nozzle 122 and/or the turbulence device 124 can be modulated on demand, so that the developer nozzle 122 or the turbulence device 124 can be disposed above the wafer 141. Alternatively, the developer nozzle 122 and the turbulence device can be disposed independently rather than cooperatively connected with the movable device 123. In addition, the function of the carrier 121 is used to carry the wafer 141.

Please continuously refer to FIG. 7(B), which shows the developer nozzle disposed above the wafer in the first preferred embodiment of the present invention. In FIG. 7(B), the developer nozzle 122 provides a developer 100 on the wafer 141. Please continuously refer to FIG. 7(C), which shows the turbulence device disposed above the wafer in the first preferred embodiment of the present invention. In FIG. 7(C), turbulence is provided by descending the uneven outer bottom surface 125 of the turbulence device 124 to contact with or immerse in the developer, so as to achieve the uniformity of developer concentration. The bottom surface can be constructed from a plurality of pyramid structures, a plurality of cubic structures, a plurality of hemispheric structures, a plurality of irregular structures and the composition thereof. The material of the bottom surface can be metal, nonmetal and the appropriate combination thereof.

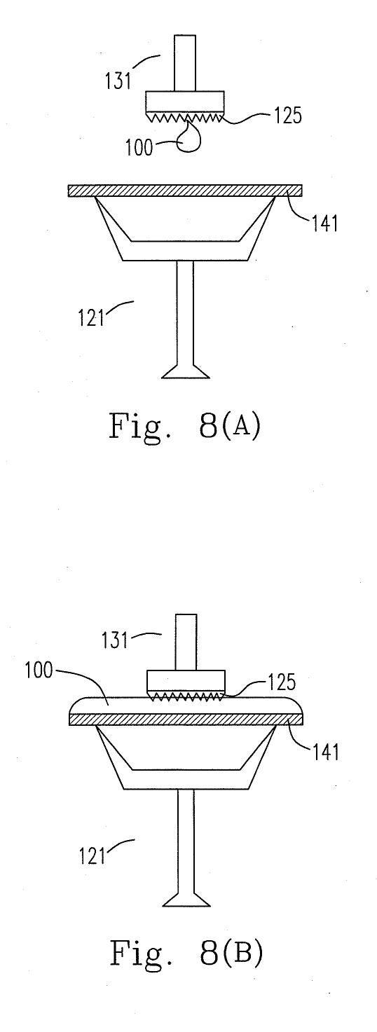

Please refer to FIG. 8(A), which shows the apparatus for improving the uniformity of developer concentration in the second preferred embodiment of the present invention. The apparatus includes a carrier 121 and a turbulence device 131. The carrier 121 is utilized to carry the wafer 141. The turbulence device 131, disposed above the wafer 141, can reserve the developer 100 therein and includes an uneven outer bottom surface 125. Please continuously refer to FIG. 8(B), which shows turbulence of the developer by the turbulence device in the second preferred embodiment of the present invention. The wafer 141 is carried by the carrier 121. When the developer 100 is dropped on the upper surface of the wafer 141, turbulence is provided on the developer 100 by descending the uneven outer bottom surface 125 of the turbulence device 131 to contact with or immerse in the developer. The bottom surface can be constructed from a plurality of pyramid structures, a plurality of cubic structures, a plurality of hemispheric structures, a plurality of irregular structures and the composition thereof. The material of the bottom surface can be metal, nonmetal and the appropriate combination thereof. According to the above-mentioned illustration, the device for improving the uniformity of developer concentration is provided.

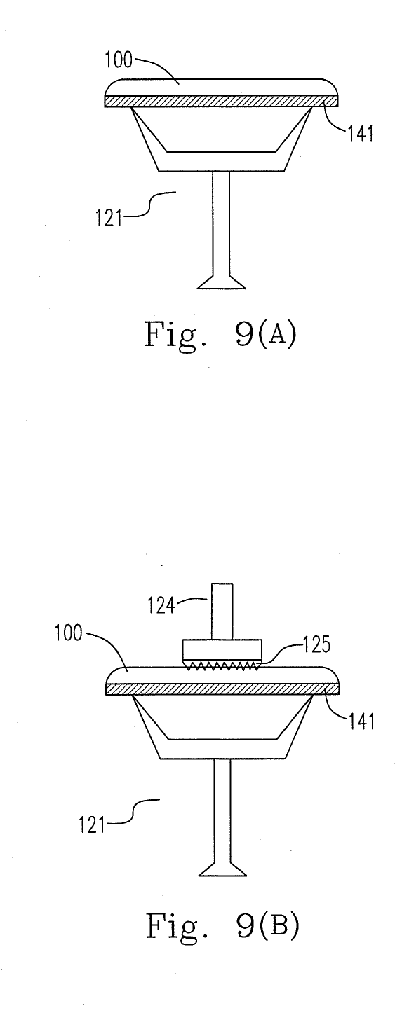

Please refer to FIG. 9(A), which shows the apparatus for improving the uniformity of developer concentration in a third preferred embodiment of the present invention. The apparatus includes a carrier 121 to carry the wafer 141, and a developer 100 is provided on the wafer 141. In the third preferred embodiment, the developer 100 not only is provided from the nozzle, but also from other instrument or artificially provided. The nozzle or other instrument is separately configured from the turbulence device (see FIG. 9(B)). Please continuously refer to FIG. 9(B), which shows turbulence on the developer by the turbulence device in the third preferred embodiment of the present invention. The turbulence device 124 is disposed above the wafer 142, and the turbulence device 124 includes an uneven outer bottom surface 125. Turbulence is provided on the developer 100 by descending the uneven outer bottom surface 125 of the turbulence device 124 to connect with or immerse in the developer 100. The bottom surface can be constructed from a plurality of pyramid structures, a plurality of cubic structures, a plurality of hemispheric structures, a plurality of irregular structures and the composition thereof. The material of the bottom surface can be metal, nonmetal and the appropriate combination thereof. According to the above-mentioned illustration, the device for improving the uniformity of developer concentration is provided.

The consumption rate of the developer is increased with the transparent pattern density of the photomask. To avoid the problem that the consumption rate of the developer is diverse at each position on the wafer, turbulence is generated in the developer by the uneven outer bottom surface or the mega-sonic vibrator. Turbulence can improve the uniformity of developer concentration so as to maintain the uniform consumption rate of the developer. The present invention need not continuously provide the fresh developer. Therefore, the quantity of developer and the developing time can be reduced when the developer is lithographed on the pattern of the photomask, and CD of the wafer is also maintained in an appropriate range.

In conclusion, the present invention actually provides a method for improving the uniformity of the developer concentration, where turbulence of the developer is produced because of the uneven outer bottom surface of the turbulence device or the mega-sonic vibrator. The present invention overcomes the drawbacks that the fresh developer is continuously supplied to result in the much higher operation cost and operation time in the prior art. The present technique is much simpler, saves manufacturing cost, maintain the CD value, has higher application diversities and indeed has the industrial usefulness.

While the invention has been described in terms of what is presently considered to be the most practical and preferred Embodiments, it is to be understood that the invention needs not be limited to the disclosed Embodiments. On the contrary, it is intended to cover various modifications and similar arrangements included within the spirit and scope of the appended claims, which are to be accorded with the broadest interpretation so as to encompass all such modifications and similar structures.

What is claimed is:

1. A developer homogenizing method, comprising steps of:
(a) providing a substrate;
(b) substantially uniformly distributing the developer on the substrate;
(c) developing the substrate and disturbing the developer simultaneously; and
(d) drying out the developer.

2. The method according to claim 1, wherein the substrate is a wafer.

3. The method according to claim 1, wherein the step (b) is performed by a spin coating process.

4. The method according to claim 1, wherein the developer disturbing step is processed by means for generating a turbulence in the developer.

5. The method according to claim 1, wherein the developer disturbing step is processed by immersing a turbulence device in the developer.

6. The method as claimed in claim 4, wherein the turbulence generating means is a mega-sonic device.

7. A homogenizing apparatus for a developer, comprising:
a carrier supporting thereon a substrate;
a dropping unit providing the developer on the substrate; and
a turbulence device disposed above the carrier for disturbing the developer.

8. The apparatus according to claim 7, wherein the turbulence device is a mega-sonic device.

9. The apparatus according to claim 7, wherein the turbulence device has an uneven outer bottom surface contacted the developer.

10. The apparatus according to claim 9, wherein the uneven outer bottom surface is selected from a group consisting of a plurality of pyramid structures, a plurality of cubic structures, a plurality of hemispheric structures, a plurality of irregular structures and a combination thereof.

11. The apparatus according to claim 9, wherein the uneven outer bottom surface is made of a material selected from a group consisting of a metal, a nonmetal and a combination thereof.

12. The apparatus according to claim 7, wherein the dropping unit is a developer dispenser disposed above the carrier.

13. The apparatus according to claim 7, wherein the dropping unit and the turbulence device are configured on a movable device.

14. The apparatus according to claim 7, wherein the dropping unit is configured in the turbulence device.

15. The apparatus according to claim 7, wherein the dropping unit is a nozzle.

16. A homogenizing apparatus for a developer, comprising:
a carrier supporting thereon a substrate;
a developer dispensing unit located on top of the substrate to provide a developer on the substrate; and
means for disturbing the developer evenly.

17. The apparatus according to claim 16, wherein the disturbing means is a mega-sonic device.

18. A homogenizing method for a developer, comprising steps of:
providing a substrate receiving thereon the developer; and
evenly disturbing the developer when the substrate is to be developed by the developer.

19. The method according to claim 18, wherein the substrate has two opposite surfaces, and the method further comprises a step of distributing the developer over one of the two opposite surfaces by a spin coating process.

20. The method according to claim 18, wherein the developer has a distribution of a concentration and the disturbing step is used for homogenizing the distribution of the concentration.
